(19) United States
(12) Patent Application Publication
(10) Pub. No.: US 2019/0211584 A1
(43) Pub. Date: Jul. 11, 2019

(54) HANDLE WITH FLOOR AND/OR CEILING LOCK

(71) Applicant: PBA S.P.A., TEZZE SUL BRENTA (VI) (IT)

(72) Inventor: MASIERO FRANCESCA, TEZZE SUL BRENTA (VI) (IT)

(21) Appl. No.: 16/223,804

(22) Filed: Dec. 18, 2018

(30) Foreign Application Priority Data
Jan. 10, 2018 (IT) 102018000000636

(51) Int. Cl. E05B 63/00; E05B 63/08; E05B 15/00; E05C 1/06

(52) U.S. Cl. CPC E05B 63/006; E05B 63/08; E05Y 2900/132; E05C 1/06; E05B 15/0033

(57) ABSTRACT

Described is a handle (10) with floor and/or ceiling lock which comprises:
a first part (11) and a second part (12) one having an internal cavity (14);
a connecting element (15) having two opposite ends (151, 152) to each of which can be fixed one of the parts (11, 12);
a closing/opening device (17) comprising a knob element (18), a latch element (19) and a transmission mechanism (20) which connects them.

The second part (12) has a housing seat (22) for a Mortise cylinder unit (100) which has a lever (101) which is rotatable with respect to tan actuation axis (A).

The transmission mechanism (20) comprises a crank element (23) configured in such a way as to transform a rotation of the knob element (23) into a translation of the latch element (19) with respect to the cavity (14).

The crank element (23) faces in the housing seat (22) in such a way that a protrusion (231) of the crank element (23) interferes with a trajectory of rotation of the lever (101) of the Mortise cylinder unit (100) for operating the latch element (19).

This invention relates to a handle with floor and/or ceiling lock.

More specifically, the invention relates to a handle of the type with a gripping element which, in use, extends vertically and which has at least and upper and/or lower end touching the floor and/or the ceiling or an upper contact, respectively.

A latch is slidably housed in the gripping element and can be actuated by engaging a seat provided in the floor and/or ceiling, respectively.

There are prior art handles of this type, according to the preamble of claim 1.

A problem associated with these handles and which is currently particularly felt derives from the fact that when these handles are ordered for installation in an entire building or in complex, for example managerial, they must be adapted to the cylinder units which are chosen by the customer.

According to this invention, the expression “cylinder unit” means a device which, by using a key which can be inserted in an actuation cylinder, allows the actuation of a lock, meaning a mechanism which, mounted in a door, allows the closing of the latter by means of locking devices such as bolts, latches and the like.

In fact, the selection of the model of the cylinder unit is correlated to the security of the access to the building. For this reason, the cylinder unit model will, in general, be selected which best corresponds to the security needs of the customer and which allows access to the rooms to be divided according to the criteria desired by the customer. For example, the security manager for the building may be provided with a key which allows the opening of any cylinder unit whilst cleaning staff must be provided with keys which allow access only to groups of rooms of the building, where, on the hand, the users can be provided with keys which allow the opening of one or more entrance doors to the building and to the door of the room assigned to them.

For this reason, if a manufacturer of handles is requested to supply a set of handles for installation in a building or in a complex, the handles will have to be compatible with the locks selected by the customer.

This requires, in general, that the handle manufacturers adapt their models of handles to the locks selected each time.

Therefore, each project for the installation of handles in a building or complex usually requires the production of a dedicated solution of handles or at least adapted to the particular features of the project itself.

The problem at the basis of this invention is therefore to provide a universal handle, that is to say, a handle designed substantially for any make of cylinder unit which is currently on the market.

The main aim of this invention is to make a handle with floor and/or ceiling lock which offers a solution to this problem by overcoming the above-described drawbacks of the handles described above.

Within the scope of such a task, it is the aim of the invention to provide a handle with floor and/or ceiling lock which allows a dual actuation, that is to say, by means of a knob, from one side of the door, and by means of the key of the cylinder unit, from the other side of the door.

Another aim of the invention consists in making a handle with floor and/or ceiling lock which can be easily actuated by persons having limited dexterity.

A further aim of the invention consists in providing a handle with floor and/or ceiling lock which is easy to install and which allows an easy replacement of the cylinder unit.

This aim, as well as these and other aims which will emerge more fully below, are attained by a handle with floor and/or ceiling lock according to appended claim 1.

Detailed features of the handle with floor and/or ceiling lock according to the invention are indicated in the dependent claims.

Further features and advantages of the invention will emerge more fully from the description of a preferred but not exclusive embodiment of a handle with floor and/or ceiling lock according to the invention, illustrated by way of non-limiting example in the accompanying drawings, in which:

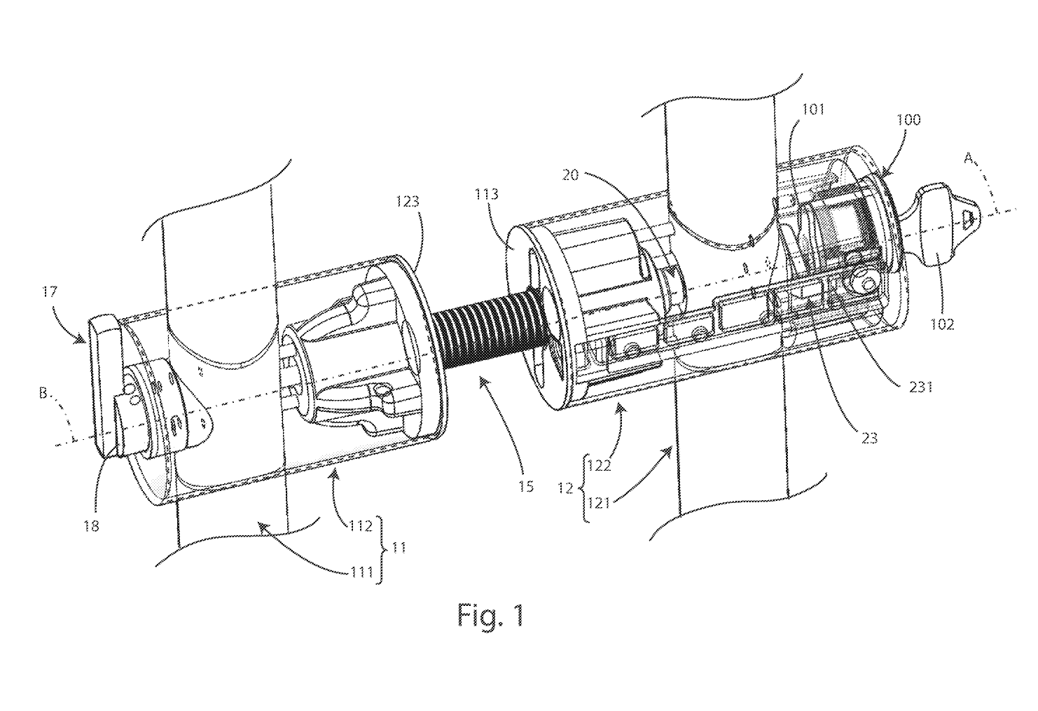

FIG. 1 illustrates a perspective view of a detail of a handle according to the invention;

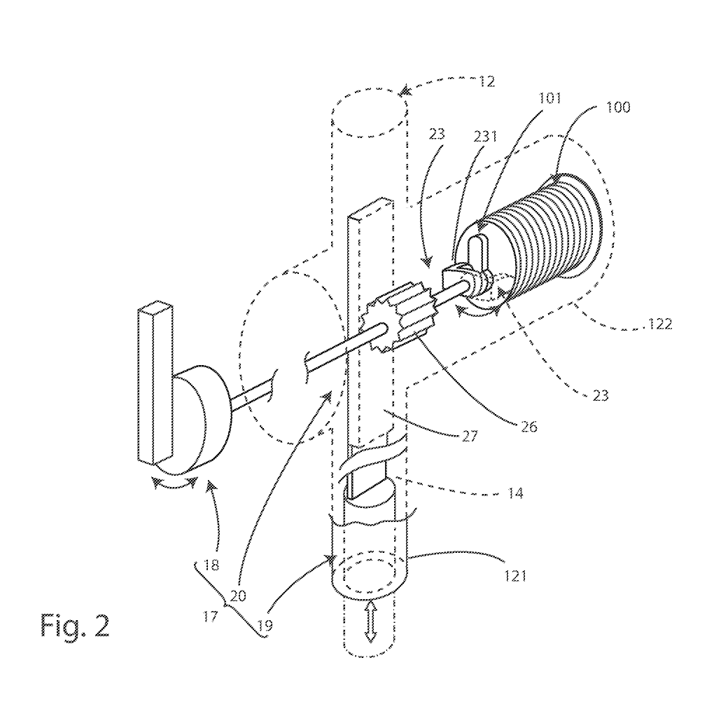

FIG. 2 illustrates a simplified diagram of the handle of FIG. 1;

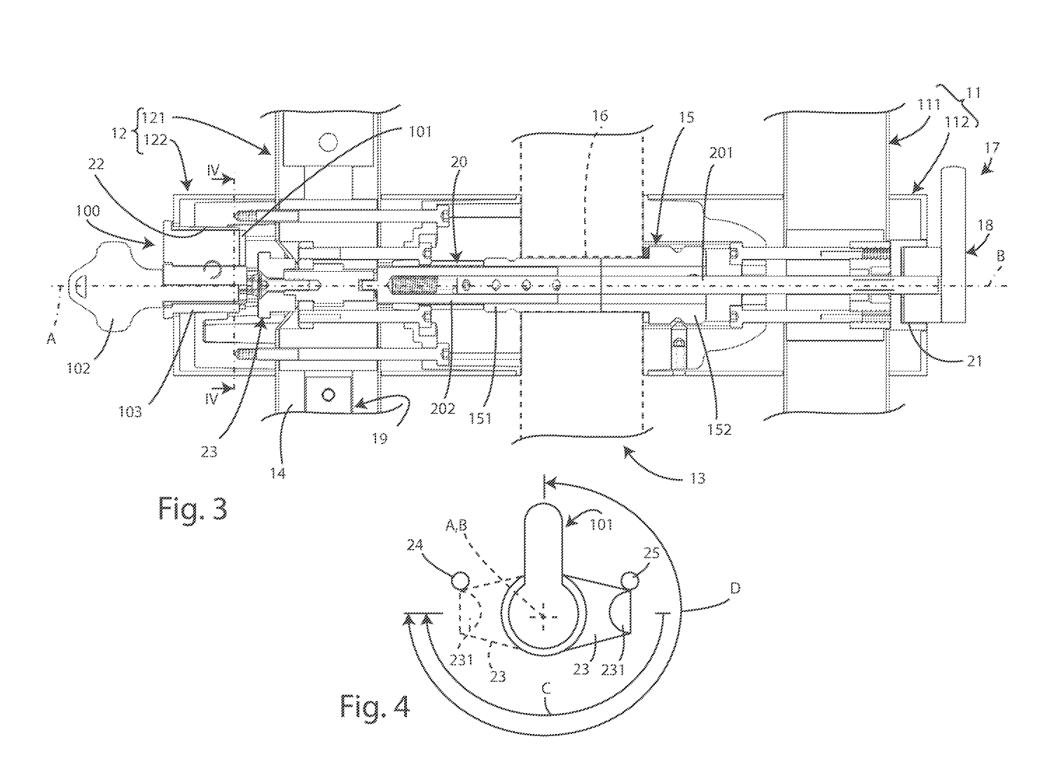

FIG. 3 illustrates a longitudinal section of the handle of FIG. 1;

FIG. 4 illustrates a detail relative to the lever of the Mortise cylinder unit of the crank element of the handle of the previous drawings seen according to the reference plane IV-IV of FIG. 3.

With particular reference to the above-mentioned drawings, the numeral 10 denotes in its entirety a handle with floor and/or ceiling lock which in a traditional manner advantageously comprises:
a first part 11 and a second part 12 each designed to engage one of the faces of the leaf 13 of a door and designed to be gripped to move the leaf 13; at least one of the parts 11, 12 having an internal cavity 14;
a connecting element 15 configured for being inserted in a through fashion in a hole of the leaf 13 and having two opposite ends 151, 152 to each of which can be fixed one of the parts 11, 12;
a closing/opening device 17 which can comprise a knob element 18, a latch element 19 and a transmission mechanism 20 which mechanically connects the knob element 18 to the latch element 19.

The knob element 18 is advantageously connected in a rotatable fashion to the first part 11.

The latch element 19 is preferably movable, and more preferably slidable with respect to the cavity 14 between an open position, in which it is retracted into the cavity 14, visible, for example, in FIG. 2, and a closed position in which it project from the cavity 14, shown as a dot-dashed line in FIG. 2.

The transmission mechanism 20 is preferably configured in such a way as to transform a rotation of the knob element 18 into a movement, and preferably into a translation, of the latch element 19 with respect to the cavity 14, between the open position and the closed position, for extending the latch element from the cavity 14 or for retracting it in the latter.

The second part 12 advantageously has a housing seat 22 for a Mortise cylinder unit 100 which has a lever 101 which is rotatable with respect to tan actuation axis A.

Advantageously, each of the parts 11, 12 comprises a gripping element 111, 121 which extend at least mainly in a direction of extension and a support 112, 122 which can be fixed to the connecting element 15 and fixed to the gripping element 111, 121.

Preferably, the support 112 of the first part 11 advantageously comprises a support seat 21 for the knob element 18 and the support 122 of the second part 12 is preferably equipped with a housing seat 22 for the Mortise cylinder unit 100.

The Mortise cylinder unit 100 will satisfy the requirements of the standards selected by the manufacturer of the handle 10 or indicated by the customer.

In fact, as is known, Mortise locks are standardised devices.

For example, the Mortise cylinder unit 100 can preferably satisfy the USA standard ANSI A156.13, ML9000-series.

The cavity 14 can be inside any one of the gripping elements 111, 121 or both the gripping elements 111, 121 can have an inner cavity 14 and, correspondingly at least one latch element 19.

In particular, in a traditional manner, the gripping elements 111, 121 will be shaped and dimensioned in such a way that, once the handle 10 is fitted on a leaf 13, an opening of the cavity 14 faces towards the floor which will have a hole which can be engaged by the latch element 19 when the leaf is closed.

In a similar manner, as applicable, the hole which can be engaged by the latch element 19 can be provided on the ceiling or on an architrave of the frame to which the leaf is articulated, so that when the leaf is closed the latch element 19 can be extended from the cavity and engage the hole, thus blocking the door.

Clearly, if a single gripping element 111 or 112 is provided with the cavity, two latch elements 19 can be provided which can be activated for extending symmetrically towards the floor and towards the ceiling, respectively, for engaging, when the leaf 13 is closed, the same number of holes provided correspondingly on the floor and on the ceiling, or architrave.

Usually, the part 11 or 12 which will be equipped with the Mortise cylinder unit 100 is designed to face the outside of the room which can be closed by the leaf 13.

Clearly, depending on the needs each of the parts 11 and 12 can extend to the ceiling/architrave and/or ceiling and be provided with one or two latch elements 19.

According to the invention, the handle 10 has a particular peculiarity in that preferably the transmission mechanism comprises a crank element 23 which is rotatable with respect to an operational axis B and is configured in such a way as to transform a rotation of the crank element 23 into a movement, preferably a translation, of the latch element 19 with respect to the cavity 14.

Advantageously, the housing seat 22 is configured in such a way that, when a Mortise cylinder unit 100 engages it, the axis of actuation A of the lever 101 substantially coincides with the operating axis B of the crank element 23.

The characteristic that the axis of actuation A substantially coincides with the operating axis B means that preferably they coincide however they can be offset so as not to adversely affect the interaction between the crank element 23 and the lever 101 as described in detail below.

The crank element 23 is advantageously equipped with a protrusion 231 which protrudes along a direction substantially parallel and offset with respect to the operating axis B;

The crank element 23 preferably faces in the housing seat in such a way that when a Mortise cylinder unit 100 engages the housing seat 22 then the protrusion 231 interferes with a trajectory of rotation of the lever 101 of the Mortise cylinder unit 100 for being engaged and dragged in rotation to operate the latch element 19.

Advantageously, the transmission mechanism 20 has an assembly configuration in which the crank element 23 has an angular assembly position with respect to the housing seat 22 which is predefined.

For example, as shown in FIG. 1, according to said assembly position the protrusion 231 can be in an angular position, around the operating axis B, rotated by 90° with respect to the vertical direction, when the handle 10 is installed on a leaf 13 in situ.

The case is particularly suitable for the situation in which a Mortise cylinder unit 100 is housed in the housing seat 22 oriented in such a way that the lever 101 extends vertically, as visible, for example, in FIGS. 1-2.

The transmission mechanism 20 is advantageously configured in such a way that a predetermined closing rotation C of the crank element 23, starting from said assembly position, is followed by a translation of the latch element 19 from the open position to the closed position.

In order to facilitate use of the handle 10 by limited dexterity, said predetermined closing rotation C is advantageously less than 360°, preferably substantially between 180° and 210°, more preferably equal to 180°, as shown in FIG. 4.

Moreover, the limitation of the closing rotation C to values of less than 360° makes it possible to prevent, following a complete rotation, that is to say, 360° or more, that the key 102 can be removed thereby blocking the rotor 103 and, consequently, the closing/opening device 17 in one of the two limit positions thereby preventing an opposite manoeuvre by actuation of the knob element 18.

Advantageously, the transmission mechanism 20 is configured in such a way a rotation of the knob element 18 corresponds to a proportional rotation of the crank element 23.

Preferably, the transmission mechanism 20 is configured in such a way that the knob element 18 and the crank element rotate in an integral fashion, however in alternative embodiments the transmission mechanism 20 can be configured in such a way as to determine a selected transmission ratio between a rotation of the knob element 18 and the crank element 23.

This may be done, for example, in order to limit the effort required for actuating the closing/opening device 17 so that there is a greater rotation of the knob element 18 with respect to that of the crank element 23.

Advantageously, the transmission mechanism 20 is configured in such a way that the passage of the latch element 19 from said open position to said closed position or vice versa, is obtained by a rotation of not more than 180°, or preferably between 180° and 210°, of the knob element 18.

In this, users with limited dexterity can easily actuate the closing/opening device 17 of the handle 10.

Advantageously, the connecting element 15 is hollow and passed through by the transmission mechanism 20 and in particular by a drive rod 201 and by a connector element 202 which are designed to couple in a telescopic fashion to adapt the transmission mechanism 20 to the thickness of the leaf 13 on which the handle 10 can be fitted.

Each of the parts 11, 12 preferably has a stop face 113, 123 designed to make contact with a face of the leaf 13.

Advantageously, the parts 11, 12 can be fixed to the connecting element 15 in an adjustable fashion to adapt the distance between the stop faces 113, 123 to the thickness of the leaf 13.

The handle 10 according to the invention advantageously comprises a Mortise cylinder unit 100 which has the lever 101 facing and coaxial with the crank element 23 and positioned with respect to the latter in such a way that, following a rotation of the lever 101 about the axis of actuation A, the lever 101 engages the protrusion 231 for dragging in rotation the crank element 23.

The Mortise cylinder unit 100 advantageously has a rest position in which the lever 101 extends radially to the axis of actuation A along a direction which has a redefined angular distance D from the crank element 23 when it is in the assembly position.

Said rest position advantageously corresponds to the position in which it is possible to insert or remove the key 102 from the cylinder 103 of the Mortise cylinder unit 100.

More specifically, the angular distance of the protrusion 231 of the crank element 23, in said assembly position, from the lever 101, in said rest position, along the direction of the predefined closing rotation C, is greater than the predefined closing rotation C in such a way that following the performance of the predefined closing rotation C, the protrusion 231 does not interfere with the lever 101, as shown, for example, in FIG. 4.

In this way, if the closing/opening device 17 is actuated by means of the knob element 18, this may be rotated by the predefined closing rotation C without the crank element 23 interfering with the lever 101 of the Mortise cylinder unit 100, otherwise, if the key 102 were not inserted in the latter its cylinder 103 and therefore the lever 101 which is integral with it, would not be able to rotate and the latter would block the rotation of the crank element 23.

In order to close the closing/opening device 17 by means of the Mortise cylinder unit 100, it is necessary to rotate the lever 101, rotating the rotor 103 by means of the key 102 until engaging with the lever 101 the protrusion 231 and, acting on this, rotate the crank element 23 by the predefined closing rotation C thus moving the latch element 19 to the closed position, shown as a dot-dashed line in FIG. 2.

When the latch element 19 reaches the maximum extension in its closed position, the further rotation of the crank element 23 is advantageously prevented and, correspondingly, also that of the lever 101.

In order to extract the key 102, the operator must rotate the key in the opposite direction to that of the predefined closing rotation C by the predefined angular distance D so as to move the cylinder 103 to the configuration in which the key 102 can be withdrawn and which corresponds to the rest position of the lever 101.

In order to return the latch element 19 to the open position, the operator can actuate the key 102 rotating it in the opposite direction to that of the predefined closing rotation until engaging the protrusion 231 and also so as to rotate the crank element 23 to the assembly position of the crank element 23 which corresponds to the open position of the latch element 19.

Otherwise, in order to return the latch element 19 to the open position acting on the knob element 18 it is possible to act on the latter and, consequently, on the crank element 23, so as to return the latter to the assembly position.

Preferably, there will be two contact elements 24 and 25, both positioned so as not to interfere with the lever 101 during its rotation but so as to interfere with the crank element 23 to limit the rotation between the assembly position and that reached following the predefined closing rotation C.

According to other preferable embodiments, the contact elements 24 and 25 will be physically absent and the rotation of the crank 23 will be limited by the interference of the protrusion 231 on the body of the cylinder unit 100 or by end stops integrated in the latter. More specifically, a first contact element 24 will be positioned so as to prevent a rotation exceeding the predefined closing rotation C, and a second contact element 25 will be positioned to prevent the crank element 23 from being rotated beyond the assembly position in the opposite direction to that of the predefined closing rotation C. Basically, the use of a handle 10 according to the invention allows a supplier of handles to avoid having to adapt its models, made according to the invention, to the model of the cylinder unit selected by the customer.

In fact, lock manufacturers provide their relative locks at least in the Mortise model, as well as, possibly, in the RIM type model.

For this reason, when the customer has selected the model of the cylinder unit to be installed in the requested handles, the handle supplier can simply purchase the Mortise model of the locks selected by the customer and install them in the relative handles 100.

For this purpose, preferably, the housing seat will be threaded internally so as to couple with the thread which the Mortise cylinder units 100 have externally.

Advantageously, in the housing seat 22 there can be a stop element, not illustrated, which limits the depth of screwing of the Mortise cylinder unit 100 in the housing seat 22 to guarantee that when the Mortise cylinder unit 100 is in contact with the stop element, the lever 101 faces the crank element 23 so as to engage the protrusion 231 when the lever 101 is rotated.

In the version of the handle 10 shown in FIG. 2, the transmission mechanism 20 advantageously comprises a rack type actuation having:
a toothed radial element 26 which rotates in an integral fashion, or according to a selected transmission ratio, with the crank element 23, and
a rectilinear toothed element 27 fixed to the latch element.

The invention as it is conceived is susceptible to numerous modifications and variants, all falling within the scope of protection of the appended claims.

Further, all the details can be replaced by other technically-equivalent elements.

In practice, the materials used, as well as the contingent forms and dimensions, can be varied according to the contingent requirements and the state of the art.

Where the constructional characteristics and the technical characteristics mentioned in the following claims are followed by signs or reference numbers, the signs or reference numbers have been used only with the aim of increasing the intelligibility of the claims themselves and, consequently, they do not constitute in any way a limitation to the interpretation of each element identified, purely by way of example, by the signs or reference numerals.

1. A handle (10) with floor and/or ceiling lock comprising:
a first part (11) and a second part (12) each adapted to engage one of the faces of a leaf (13) of a door and apt to be gripped to move the leaf (13); at least one of said parts (11, 12) having a cavity (14), internal;
a connecting element (15) configured to be inserted passing through a hole of the leaf (13) and having two opposite ends (151, 152), to each of which one of said parts (11, 12) is fixable;
a closing/opening device (17) comprising a knob element (18), a latch element (19) and a transmission mechanism (20) which mechanically connects said knob element (18) to said latch element (19);
said knob element (18) is connected in a rotatable manner to said first part (11);
said latch element (19) is movable with respect to said cavity (14) between an opening position, in which it is retracted into said cavity (14), and a closing position in which it projects from said cavity (14); said transmission mechanism (20) is configured in such a way as to transform a rotation of said knob element (18) into a movement of said latch element (19) with respect to said cavity (14), to extend said latch element (19) from said cavity (14) or to retract it in the latter;
characterized in that:
said second part (12) has a housing seat (22) for a Mortise cylinder group (100) which has a lever (101) which is rotatable with respect to an actuation axis (A);
said transmission mechanism (20) comprises a crank element (23) rotatable with respect to an operating axis (B) and configured so as to transform a rotation of said crank element (23) into a translation of said latch element (19) with respect to said cavity (14);
said housing seat (22) is configured in such a way that, when a Mortise cylinder group (100) engages it, the actuation axis (A) of the lever (101) substantially coincides with the operating axis (B) of said crank element (23);
said crank element (23) is provided with a protrusion (231) which projects along a direction which is substantially parallel and offset with respect to said operating axis (B);
said crank element (23) is faced in said housing seat (22) in such a way that when a Mortise cylinder group (100) engages said housing seat (22), said protrusion (231) interferes with a trajectory of rotation of the lever (101) of the Mortise cylinder group (100) to be engaged therein and dragged in rotation, to operate said latch element (19).

2. The handle (10) according to claim 1 characterized in that said transmission mechanism (20) has a mounting configuration in which said crank element (23) has an angular mounting position with respect to said housing seat (22) which is predefined;
said transmission mechanism (20) is configured in a way such that at a predefined closing rotation (C) of said crank element (23), starting from said mounting position, a translation of said latch element (19) follows, from said opening position to said closing position;
said predefined closing rotation (C) is less than 360° and preferably comprised substantially between 180° and 210°.

3. The handle (10) according to claim 1, characterized in that said transmission mechanism (20) is configured in such a way that a rotation of said knob element (18) corresponds to a proportional rotation of said crank element (23).

4. The handle (10) according to claim 1, characterized in that said transmission mechanism (20) is configured in such a way that the passage of said latch element (19) from said opening position to said closing position or vice versa, is obtained by rotating said knob element (18) substantially between 180° and 360° and preferably between 180° and 210°.

5. The handle (10) according to claim 1, characterized in that said connecting element (15) is hollow and crossed by said transmission mechanism (20); each of said parts (11, 12) has a stop face (113, 123) apt to abut against a face of the door (13), said parts (11, 12) being fixable to said connecting element (15) in an adjustable way to adapt the distance between said stop faces (113, 123) to the thickness of the leaf (13).

6. The handle (10) according to claim 2, characterized in that it comprises a Mortise cylinder group (100) having said lever (101) facing and coaxial to said crank element (23) and positioned with respect to the latter so that, following a rotation of said lever (101) about said axis of actuation (A), said lever (101) engages said protrusion (231) to drag in rotation said crank element (23).

7. The handle (10) according to claim 6 characterized in that said Mortise cylinder group (100) has a rest position in which said lever (101) extends radially to said an axis of actuation (A) in a direction that has a predefined angular distance (D) from said crank element (23) in said mounting position.

8. The handle (10) according to claim 7 characterized in that the angular distance of the protrusion (231) of said crank element (23), in said mounting position, from said lever (101), in said rest position, along the direction of said predefined closing rotation (C) is greater than said predefined closing rotation (C) in such a way that, following completion of said predefined closing rotation (C), said protrusion (231) does not interfere with said lever (101).

9. The handle (10) according to claim 1, characterized in that each of said parts (11, 12) comprises a gripping element (111, 121) which develops at least predominantly in a developing direction and a support (112, 122) fixable to said connecting element (15) and fixed to said gripping element (111, 121); where the support (112, 122) of said first part (11) provides a support seat (21) for said knob element (18) and the support (112, 122) of said second part (12) is provided with said housing seat (22) for said Mortise cylinder group (100).

10. The handle (10) according to claim 9 characterized in that said cavity (14) is internal to the gripping element (111, 121) of said first part (11) and/or to the gripping element (111, 121) of the second part (12).
